(19) United States
(12) Patent Application Publication
(10) Pub. No.: US 2011/0216160 A1
(43) Pub. Date: Sep. 8, 2011

(54) SYSTEM AND METHOD FOR CREATING PSEUDO HOLOGRAPHIC DISPLAYS ON VIEWER POSITION AWARE DEVICES

(76) Inventor: Jean-Philippe Martin, Austin, TX (US)

(21) Appl. No.: 12/877,741

(22) Filed: Sep. 8, 2010

Related U.S. Application Data
(60) Provisional application No. 61/240,394, filed on Sep. 8, 2009.

(51) Int. Cl. H04N 5/89

(52) U.S. Cl. 348/40; 348/E13.001

(57) ABSTRACT

A pseudo holographic visual effect is produced by acquiring at least two actual images of a subject wherein each image represents a different viewing angle of the single subject. Intermediary images corresponding to other viewing angles of the subject may be extrapolated from the two actual images or two adjacent images if a sufficient number of actual images are not available to create the desired level of resolution. To create the effect, an initial start image is displayed. Computer based sensors or camera images from a camera are then used to determine any movement of the device or user from the initial position at which the initial image was displayed. Once movement is detected or once the position of the viewer is determined, the initial image is replaced with an image that corresponds to the change in the detected viewing angle or with an image that corresponds to the viewing angle of the viewer. This creates a pseudo holographic effect whereby the orientation of subject of the image appears to remain fixed despite the display or the viewer being moved. Additional layers for the image can be created by acquiring images of a background separately, creating a set of images that correspond to different viewing angles of the background and overlaying the background images with subject images during display.

### CROSS-REFERENCES TO RELATED APPLICATIONS

The present application claims priority from co-pending U.S. Provisional Patent Application Ser. No. 61/240,394 filed Sep. 8, 2009.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### FIELD OF THE INVENTION

The present invention relates generally to the display of holographic images. More particularly, the invention relates to a system and method for the production and display of pseudo holographic images generated from stereoscopic natural and synthetic images, or from photographs taken with multiple cameras set up to point concentrically towards the subject photographed, on viewer position aware devices such as cell phones, PDA's, computer monitors etc.

### BACKGROUND OF THE INVENTION

The three dimensional (3D) display of images using the technique of stereoscopy is well known in the art. The stereoscopic viewing of 3D images requires cumbersome use of special eye wear and display equipment. For example, U.S. Pat. No. RE39342 (Starks et. al.) discusses a method for converting source images to synthesized stereoscopic images where at least one of the images has been modified relative to the source image and the modified stereo images are viewed through stereo viewing glasses.

Auto-stereoscopic 3D images are an improvement over conventional stereoscopic 3D images. Unlike stereoscopic 3D images, no special glasses are needed to view these images to experience the illusion of depth in the scene presented. The 3D images generated by autostereoscopy are the result of a simulated parallax effect produced by a range of multiple available viewing angles. U.S. Pat. No. 7,446,733 (Hirimai) provides for the projection of a three dimensional still or dynamic image without any need for dedicated eye glasses or coherent light.

Generation of stereoscopic images from 2D images has been achieved by various methods and processes. For example, Intl. Apl. No. PCTIKR2008/000015 (Kim) discloses a method that generates stereoscopic images from 2D images using a mesh map. 3D images for display have also been generated from 2D images using the technique of integral photography. For example, U.S. Pat. No. 7,142,232 (Kremen) describes a method and apparatus for reducing a three-dimensional scene to an integral photograph or fabricating holograms of three-dimensional scenes and thereafter magnifying the integral photograph or holograms to project a three-dimensional image for use in home entertainment and computer technology.

Conversion of 2D images to 3D images is also well known in the art. U.S. Pat. No. 6,686,926 (Kaye) describes a dimensional process for the conversion of 2D images to 3D images which involves scanning images into a computer based system and with the use of graphic image software, creating a three-dimensional image that can be used for viewing and for re-recording for three-dimensional viewing. The process described in this patent converts only a single image to a 3D image.

3D still and dynamic images have also been generated for display on electronic devices. The auto-stereoscopic 3D display of images is gaining in popularity among users of handheld devices such as cell phones, and Personal Digital Assistant device (PDA)'s as well as laptop and desktop computers. Intl. Apl. No. PCT/US2008/050025 provides visualization of 3D video images on a stereo enabled display of a low power device, such as a mobile phone, a computer, a video game platform, or PDA. Computer implemented methods for rendering images on a two dimensional display, such as a computer, handheld device, or television screen so that the image appears to be positioned in a three dimensional space is disclosed in Intl. Apl. No. PCT/US2006/032093.

Imparting three-dimensional characteristics in a two dimensional space to create the perception of depth to images is described in Intl. Apl. No. PCT/US2008/068072. Intl. Apl. No. PCT/US2006/032093, discloses a system and computer implemented method for rendering images on a two dimensional display such as a computer, handheld device, or television screen so that the images appear to be positioned in a three-dimensional space.

Integration and display of a 3D image and a camera image in a mobile device is disclosed in U.S. App. No. 20090195539 (Kim). In this application, the processing method for the integration between the two images involves recognition of a specific image pattern defined by the user, tracing of that pattern within an image, and the interfacing of a camera image and a 3D image based on the tracing results. The 3D object is animated and rendered using a 3D graphic engine and the rendered image of the 3D object and the camera image are integrated and displayed.

Holographic displays unlike stereoscopic and auto-stereoscopic displays provide a more realistic three dimensional view of the principal objects and scenery of a captured image. 3D holographic images are not well known in the art. Currently, 3D images for handheld devices such as smart phones involve synthetic creation of dynamic images that require rotation of the phone in all directions in order to observe the movement of the image.

Systems and methods for creating, editing, and distributing stereoscopic images have also been disclosed in prior art. For example, Intl. Apl. No. W00180548 describes a system and method for the registration and distribution of stereoscopically complementary pairs of images suitable for a variety of different viewing formats.

The 3D displays currently in vogue generated on flat panel screens of handheld devices and computer monitors, use lenticular lenses or a parallax barrier. Other displays use eye tracking systems to automatically adjust the two displayed images to follow the viewer's eyes as they move their head (http://en.wikipedia.org/wiki/Autostereoscopy).

### SUMMARY OF THE INVENTION

The present invention is capable of generating pseudo holographic images from real pictures that provide depth and volume perception with either a left to right movement of the smart phone device or when held at other angles. For devices that cannot move the relative position of the viewer to the display, the invention provides the depth and volume perception. The invention uses a process of matching elements in a pair of stereoscopic images, editing the images using the techniques of morphing, tweening and image warping among others to extrapolate an intermediary image which then further undergoes a post production phase of color correction, resizing etc. before being displayed as pseudo holographic image on a mobile device such as a smart phone, PDA, laptop computer, or stationary computer monitor.

The present invention provides for the creation of pseudo holographic images that can be viewed on handheld electronic devices or on computers without the need for specialized stereoscopic glasses or expensive accessories. The 3D virtual image is created and visualized by rotating the handheld device left to right or holding the device at any another angle. The angle of the phone or handheld device will determine the picture selected to be displayed from among the actual and intermediary generated pictures. The angle at which the viewer sees the computer displays will determine the picture selected to be displayed from among the actual and/or intermediary generated pictures.

The pseudo hologram as defined by the present invention contains stereo images (or a set of images), each containing one or more layers of subjects and backgrounds. The layers are generated from different camera shots or from different image sources if the final pseudo hologram is made of mixed media. The present invention uses tools to create a pseudo hologram from a pair of stereo images or a set of images (more than one pair of stereo images, concentric shots), exports a set of intermediary images, and/or displays them natively. The process used for the generation of the holographic images and their display on the screens of the electronic devices is initiated by the acquisition and importation of a set of natural or synthetic stereoscopic images, or a set of pictures from concentric cameras.

The type of stereoscopic images that can be imported and used to generate the holographic image may be, a pair of parallel stereoscopic photographs, a pair of toe-in stereoscopic photographs, two pairs of toe-in stereoscopic photographs, frames from 3D movies, stereo images created with computer software, drawings, or any other hand or computer generated stereoscopic images. Once the images have been acquired, the acquired images undergo specific alterations to produce the desired final images. The processing procedures applied to the images may include standard photography post-production procedures such as smoothing the skin of a person, adjusting colors and contrasts, removing or adding elements to the image etc. The left and right stereoscopic images preferably undergo the same processing procedures. In stereo-photography, a standard processing procedure is to correct color, misalignment, optical distortion, or tilt. When more than one pair of stereo images or when concentric images are captured, misalignment, distortion and tilt may occur as well.

When intermediary images are extrapolated, the next phase involves matching key corresponding elements on both left and right source images. This part of the process can be done manually or through automation using pattern detection software. The elements of the main subject and back grounds as well as the boundaries between the two can be grouped separately to undergo their own transformation.

The generation of intermediary images can be achieved through a variety of processes known in the art such as morphing, tweening, image warping and the like. The idea is to extrapolate an image of the subject from a viewing angle from which the subject was not actually photographed. The intermediary images can be generated in real time or pre-generated for viewing according to the convenience and desire of the viewer. Pre-generated intermediary images would be better suited in the case of a mobile device which does not have sufficient computing power to generate the intermediary pictures in real time.

In the second post production phase certain modifications and effects are applied to images that are pre-generated, to fix errors in the generation of the intermediary images, such as transformation of some of the elements in the images to make them appear unreal. Some of the modifications and effects include, watermarking (adding text or logo), resizing, color correction, adding frames around certain images etc.

The final step is the display of the pseudo holographic image generated from the original images and processed intermediary images. At this stage, the volume and depth of the image will be apparent to the viewer of the screen in which the image is displayed and will appear as a pseudo holographic image. The holographic appearance of the image can be visualized by just the left to right movement of a hand held device or by holding the device at any angle to produce the desired holographic experience.

Desk top computer and other fixed monitors can also be used to display the pseudo holographic images generated by the present invention. In that instance, the image to be displayed would be selected according to the mouse position or the viewer's position. The viewer position can be deduced by the software processing the pictures of a webcam placed near a monitor. The software used would recognize movement and its relative position to choose the image to be displayed. In that instance, the image would appear to be tracing the viewer and would point towards the viewer.

### BRIEF DESCRIPTION OF THE DRAWINGS

FIG. 1(a) is a flowchart of a method of producing a set of images for a pseudo holographic display from stereoscopic images formed from cameras positioned at different viewing angles in accordance with an embodiment of the present invention;

FIG. 1(b) is a flowchart of a method of producing a set of images for a pseudo holographic display only from actual images formed from cameras positioned at different viewing angles in accordance with an embodiment of the present invention;

FIG. 2 is a flowchart of a method of creating layers for selecting an image for display from the set of images created by the method of FIG. 1 to use in producing a pseudo holographic display in accordance with an embodiment of the present invention;

FIG. 3 is an illustration of exemplary intermediary pictures generated by an embodiment of the present invention;

FIG. 4 is an illustration of an exemplary pseudo holographic display created by an embodiment of the present invention;

FIG. 5 is a diagram of a method of producing a set of images for use in a pseudo holographic display having layers formed from cameras positioned at different viewing angles and with different subjects in accordance with an embodiment of the present invention;

FIG. 6 is an illustration of exemplary matching points generated by an embodiment of the present invention;

FIGS. 7(a-d) are diagrams of an exemplary camera arrangements or positioning for producing a pseudo holographic display from stereoscopic images in accordance with various embodiments of the present invention;

FIG. 8 is a series of flowcharts of various alternative methods of producing a pseudo holographic display from the stereoscopic camera images created by different camera arrangements in accordance with the present invention; and

FIG. 9 is a diagram of an exemplary concentric camera arrangement for producing a pseudo holographic display from stereoscopic images in accordance with an embodiment of the present invention.

### DETAILED DESCRIPTION OF THE INVENTION

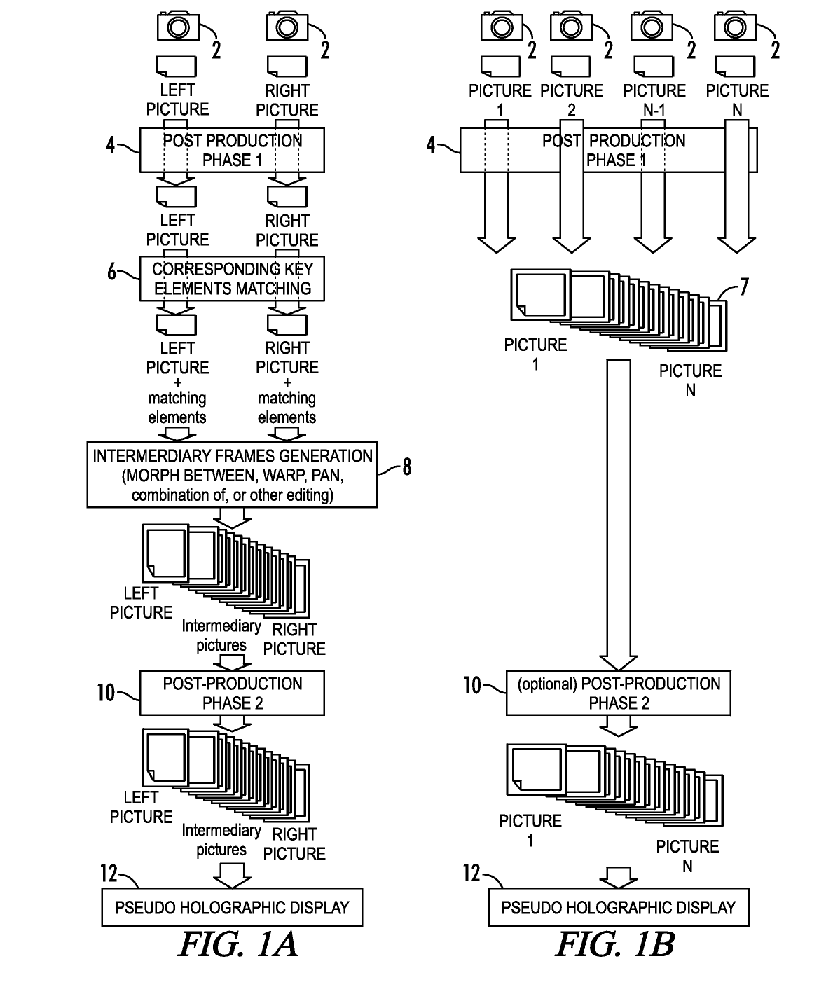

The present invention uses a set of actual, or a set of actual and extrapolated images, to produce a pseudo holographic display. Referring now to FIG. 1(a), a flowchart of a preferred method of producing such a set of images for use in pseudo holographic display from stereoscopic images formed from cameras positioned at different viewing angles is shown. The method begins in step 2 with the capturing of a left side and right side image of an object from a pair of cameras. Alternatively, one camera can be used to capture images for both the left and right viewpoints. Once the images are captured, the method proceeds to the first post production phase in step 4. In the first post production phase 4, the acquired stereoscopic images undergo specific alterations to produce the desired final images. The processing procedures in the first post production phase are preferably standard photography post-production procedures such as smoothing the skin of a person, adjusting colors and contrasts, removing or adding elements to the image etc. The left and right stereoscopic images created in step 2 preferably undergo the same post production processing procedures in step 4. The post production phase 4 may also include correction of color, tilt, distortion and alignment if desired.

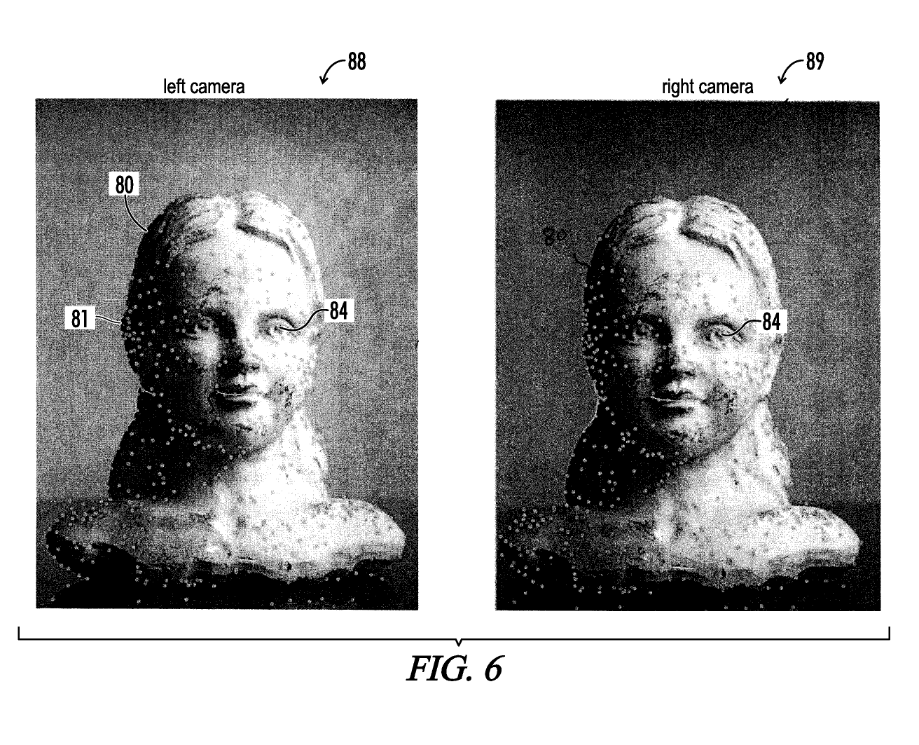

Once the first post production phase is completed, the method proceeds to step 6 wherein the corresponding key elements in the left and right side image are matched. Corresponding elements in the two images, which can be in the left and right images for a stereo pair or in simply two adjacent view points, are identified so that the images can be aligned with respect to the subject matter of the images. These matching points should correspond to readily identifiable features of the image such as the eyes of a subject or the boundaries of an object. The matching process is discussed in more detail below with respect to FIG. 6. The matching elements are then used in step 8 to generate intermediary frames based upon the processed left and right images. The generation of the intermediary images can be achieved through a variety of processes such as morphing, tweening, image warping that are known in the art. For example, a black pixel in the first image which corresponds with a white pixel in the second image will be represented by an intermediate gray pixel in the intermediary images. The intermediary images represent an extrapolation, combination or averaging of the images used to produce the intermediary images. Additional intermediary images can be created by then morphing an intermediary image with one of the original images. The point of creating the intermediary images is to create images of the subject matter from angle from which actual images were not acquired. Accordingly, if enough actual images are captured, there is no need to create any intermediary images. The more intermediary images that are created the smoother the resulting transition between images will be when the pseudo holographic effect is being produced. The intermediary images can be generated in real time or pre-generated for viewing according to the convenience and desire of the viewer. Pre-generated intermediary images are better suited for mobile devices which may not have sufficient computing power to generate the intermediary pictures in real time.

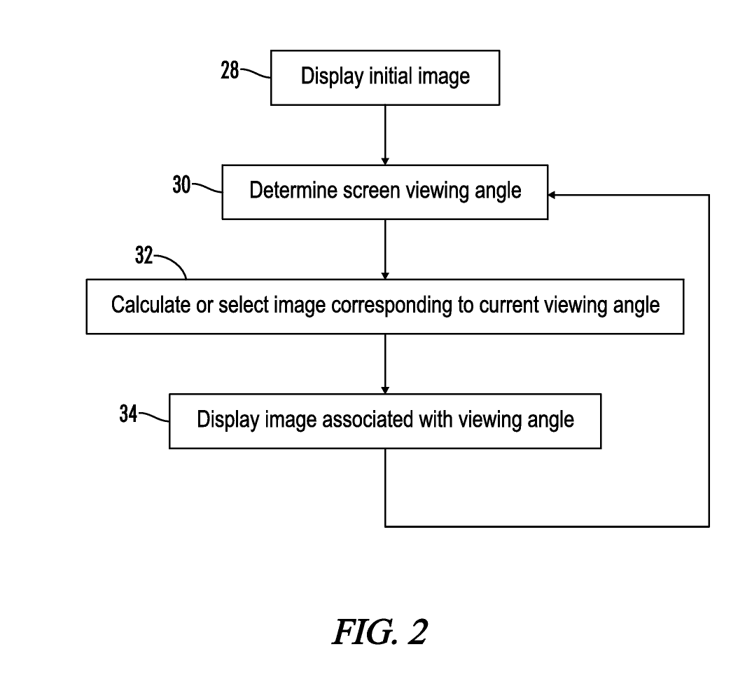

The intermediary images then undergo a second post production phase 10 wherein the intermediary images are subjected to standard image processing procedures such as smoothing the skin of a person and adjusting colors and contrasts in a manner similar to that applied to the original images in the first post production phase in step 4. The processed set of images 12 can then be used to create a pseudo holographic display as described in FIG. 2.

FIG. 1(b) is a flowchart of a method of producing a set of images for a pseudo holographic display only from actual images formed from cameras positioned at different viewing angles in accordance with an embodiment of the present invention. FIG. 1(b) is the same as FIG. 1(a) except that instead of generating intermediary images from actual images, enough actual images are captured so that the desired resolution of the pseudo holographic display can be obtained while only using actual images. This eliminates the need for steps 6 and 8 in FIG. 1(a) which are related to the generation of virtual intermediary images from the actual images. The need for a second post production phase 10 is also rendered optional. The only drawback being the need to capture a relatively large number of actual images.

Referring now to FIG. 2, a method of using the image set created in FIG. 1 to create a pseudo holographic display is shown. The method commences in step 28 with the display of an initial image. The method then proceeds to step 30 wherein a viewing angle, or change in a viewing angle, of the display on which the images will displayed is determined. The pseudo holographic display generated according to an exemplary embodiment of the present invention is best displayed by portable devices such as smart phones, portable and tablet computers, etc. which have embedded sensors for gravity and/or acceleration that can be used to determine the device's orientation in space. Application software residing in the mobile device can monitor these sensor outputs to determine the viewing angle of the device. Desk top computer and other fixed monitors can also be used to display the pseudo holographic images generated by the present invention. In such a fixed display case, the image to be displayed may be selected according to the mouse position or the viewer's position. The viewer position can also be deduced by the software processing the pictures of a webcam placed near the monitor or display. The software recognizes movement and its relative position to determine the approximate viewing angle.

Once the viewing angle is determined, an image corresponding to that viewing angle can be selected or calculated as shown in step 32. Depending upon the processing power of the device that will be used to produce the pseudo holographic display, the intermediary images may be pre-determined prior to any displaying of the images and stored in the device's memory or, if the device is quick enough, the intermediary images may be created on the fly as they are needed. Once the proper image is selected, the image is displayed in step 34 and the method returns to step 30 whereby the viewing angle of the display is again determined and another corresponding image selected. By doing so, the image will appear to the viewer to be tracing the viewer and will always point towards the original direction of the screen or viewer. Thus, when the device is turned, the orientation of the image appears to remain fixed thereby producing a pseudo holographic display.

As an example of the method of FIG. 2, assume the original images were taken from opposing sides of the subject 60 degrees apart and three intermediary images where created such that one intermediary image corresponds to viewing the subject from 15 degrees from the right most image, one intermediary images corresponds to viewing the subject from 15 degrees from the left most image and one intermediary image corresponds to viewing the subject straight on 30 degrees from both the left and right original images. If the user rotates the device 15 degrees to the right, the 15 degrees to the left intermediary image is displayed so that the subject appears to be rotating left as the display is turned to the right. This produces a pseudo holographic effect whereby the subject appears to be facing the user regardless of how the display is rotated.

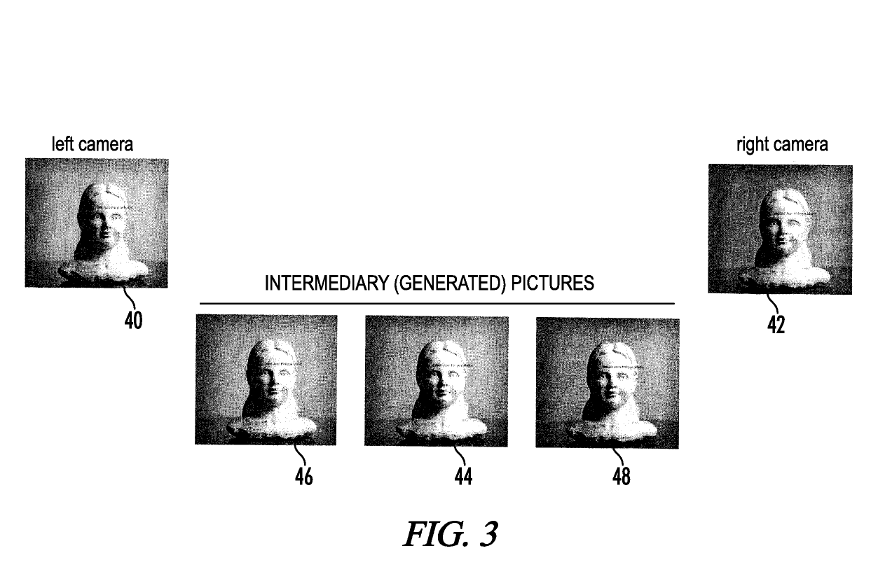

FIG. 3 is an illustration of the intermediary images created from a left camera image 40 and a right camera image 42. The left and right images are morphed to produce three frames: a center image 44 wherein the subject appears to be orientated half way between the subject's orientation in the left and right images, a mid-left image 46 wherein the subject appears to be oriented half way between the subject's orientation in the left image 40 and the middle image 44, and a mid-right image 48 wherein the subject appears to be oriented half way between the middle image 44 and the right image 42. A pseudo holographic display effect can then be created by displaying the center image 44 when the display is first initiated. When the device is turned an amount to the right that approximately or most closely corresponds to the original viewing angle of the left camera, the left image 40 is displayed. Conversely, when the device is turned an amount to the left that corresponds to the original viewing angle of the right camera (or a proportional angle value—not necessarily the exact value), the left image 42 is displayed. Partial turns to the left or right result in the center right 48 or center left 46 images being displayed.

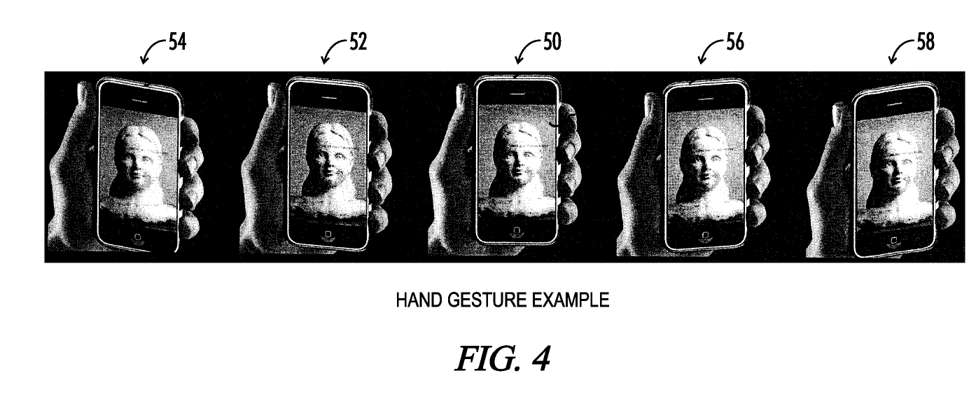

Referring now to FIG. 4, an example of the pseudo holographic display created by the present invention is shown. The initial image displayed 50 shows the subject image facing straight forward when the display of the portable device 60 is perpendicular to the viewer. When the device is rotated 15 degrees to the left, an intermediary image 52 is selected or calculated for display that corresponds to the 15 degree rotation. In a similar manner, a 30 degree rotation to the left results in the displaying of an image 54 that corresponds to the 30 degree leftward rotation of the device. A rightward rotation of the device by 15 degrees results in the image 56 being selected and displayed while a rightward rotation of 30 degrees results in the image 58 being selected and displayed. The final pseudo holographic result is that the subject appears to be facing the viewer no matter which way the device is turned.

Separate background images and subject images may be created and processed to enhance the pseudo holographic effect. When shooting a subject/person in a real environment, there may be details of the background that are obscured behind the subject/model. When the final composite image is turned, areas that were obscured by the subject in one view will move into a position whereby they should be visible to the viewer. However, if separate background and subject layers are not used, these background details are not available during creation of the intermediary images and processing. Therefore, when creating the pseudo holographic effect of the present invention with an image that has a main subject and a background, separate background and subject layers are preferably created. If the background is not shot separately from the subject, the background details in the intermediary images are extrapolated from the original actual images. The background layer is re-created by cutting out the subject. The empty spaces due to subject cut out can fall into two categories: space that appear in one of the actual images and disappear in the other actual image. These spaces or elements get warped from the actual position in the actual image they appear in to the position and size they would appear at if the subject was not in the actual image.

The basic process to add layers is to take a photo of the environment before the subject is put into place so that two pseudo holographic images can be created: one of the background/environment and one of just the subject. Each viewpoint image has a background layer (the corresponding viewpoint of the environment) and the subject layer (the corresponding viewpoint of subject) which is transparent around the subject so that the user sees through to the background layer. Alternatively, the subject is cutout and put in a layer in front of the background layer.

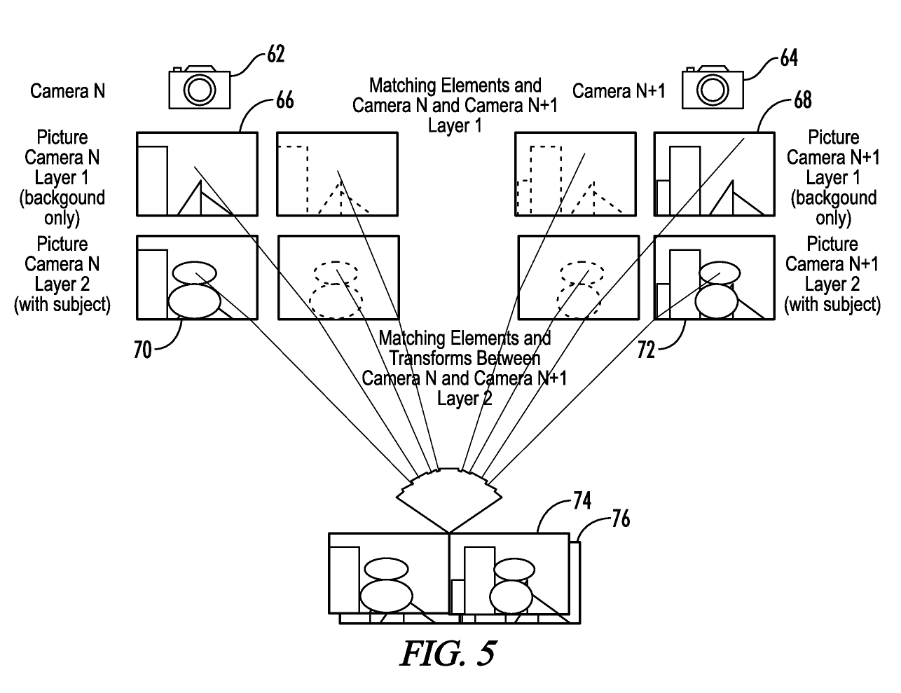

Referring now to FIG. 5, a diagram of a method of creating separate layers for use in producing a pseudo holographic display in accordance with an embodiment of the present invention is shown. The method of FIG. 5 creates separate background and subject layers from images created by a first camera 62 with a first viewing angle and a second camera 64 having a second viewing angle. Each camera 62 and 64 is used to create one image with only a background present 66 and 68 and one image with a subject present 70 and 72. While separate cameras 62 and 64 are used for exemplary purposes, those skilled in the art will readily appreciate that a single camera can be used and repositioned as necessary. The background of the subject images 70 and 72 can be the same as the background images 66 and 68 or the subject images 70 and 72 can be done in green screen whereby the subject/person is shot in front of a green/blue screen and then the background images 66 and 68 added to the subject images 70 and 72 to make it appear the subject/person was in a particular environment where they were not actually present.

Once the initial subject images and background images are acquired, matching elements in each of the layers are then determined so that intermediary images can be created for both the subject and background layers of the images. A separate set of intermediary images are created from both the background images 66 and 68 and subject images 70 and 72 to produce separate sets of background images 76 and subject images 74 for use in producing the pseudo holographic effect. Images 74 and 76 are intermediary images composed of intermediary subject images from generated 70 and 72 combined with intermediary background images generated from 66 and 68. When movement of the device or user is detected, both a background image and a subject image corresponding to the change in viewing angle are selected for display. When the images are displayed, the subject images 70 and 72 and corresponding intermediary generated images between 70 and 72 are layered or placed in front of the background images 66 and 68 and corresponding intermediary generated images between 66 and 68. The pseudo holographic images can then be displayed such that both the background and the subject appear to follow the viewer. A green screen can be used to shoot the subject and the background added in post production with the viewing angle carefully matched to the subject. The background can be a real scene, or a calculated 3D environment, or a combination.

Referring now to FIG. 6 an illustration of the identification of matching elements in accordance with an embodiment of the present invention is shown. Points such as the outlines of the head of the subject 80, the line of the lips of the subject 82 and the eyes of the subject 84 are matched between the left 88 and right 89 images. These points are then used to align the images prior to application of a standard morphing algorithm to the images. Any number of matching points can be used depending upon the desired smoothness of the transition between the images. Morphing can export as many intermediary viewpoints as desired. The number of intermediary images generated (or granularity) depends on the resolution of the display that images will be showed on and the distance of the viewer. Point 81 towards the edge of the subject that will disappear from image 88 to image 89 or point 82 disappearing from 89 to 88 are treated differently. They form elements that wrap around/behind the subject. They undergo a different geometrical transform and get placed in a layer behind the morphed elements which are cut out and placed in a front layer.

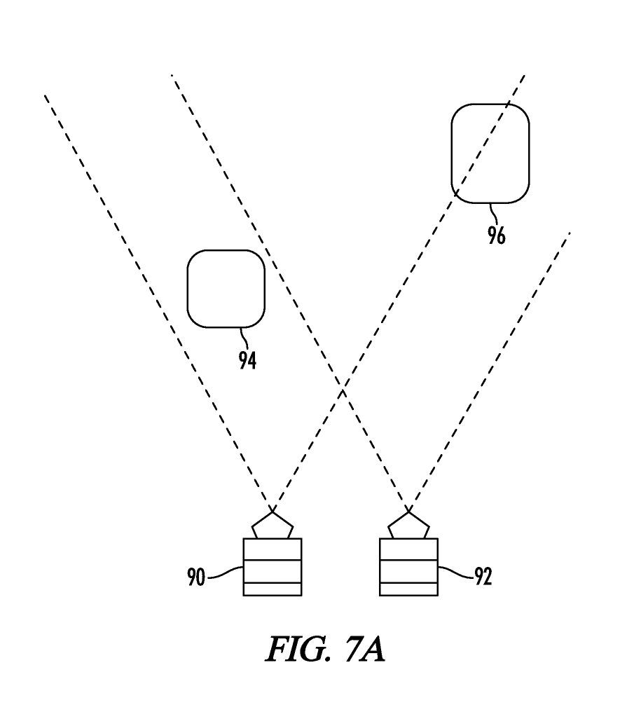

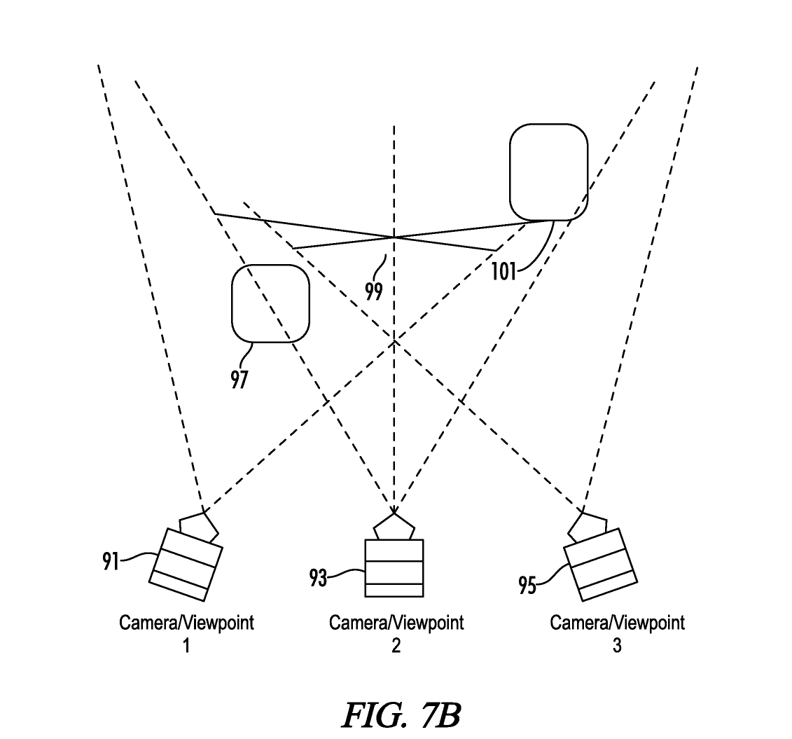

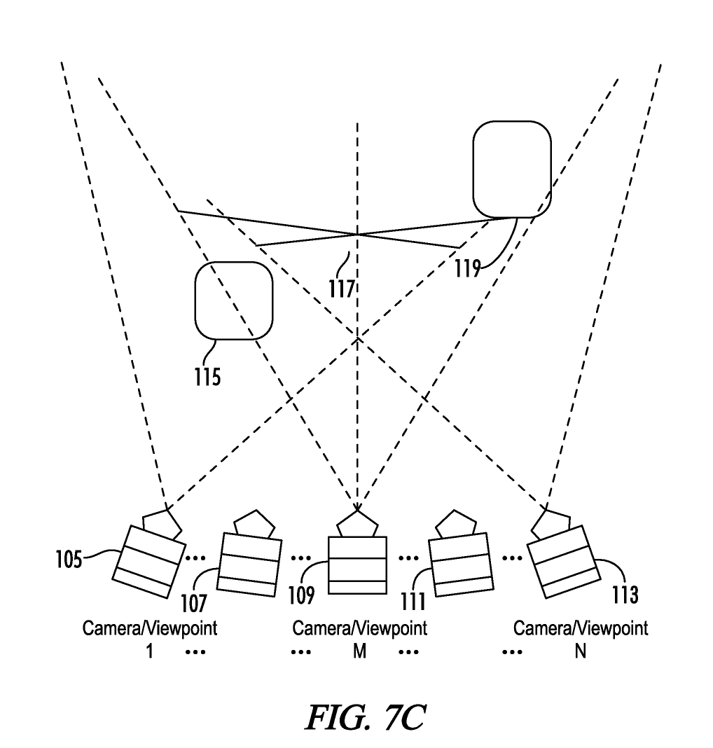

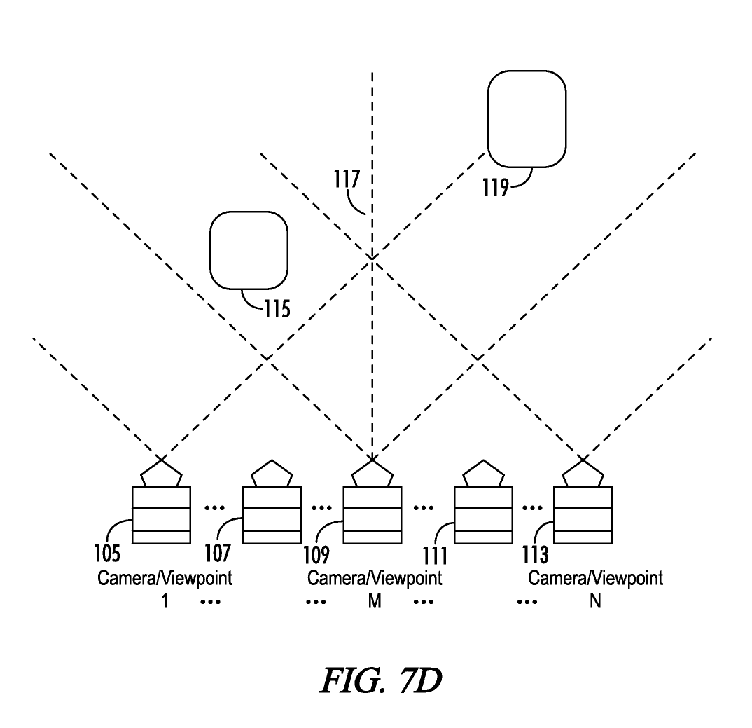

FIG. 7(a) is a diagram of an exemplary stereoscopic camera arrangement for producing a pseudo holographic display from stereoscopic images in accordance with an embodiment of the present invention. The cameras 90 and 92 are positioned so that each camera has a different viewing angle with respect to the subjects 94 and 96 to be displayed.

FIG. 7(b) is a diagram of an exemplary linear camera arrangement using three cameras for producing a pseudo holographic display from images in accordance with an embodiment of the present invention. The cameras 91, 93 and 95 are positioned so that each camera has a different viewing angle with respect to the subjects 97, 99 and 101 to be displayed.

FIG. 7(c) is a diagram of an exemplary linear camera arrangement for producing a pseudo holographic display from images in accordance with an embodiment of the present invention. The five cameras 105, 107, 109, 111 and 113 are positioned so that each camera is pointed in a slight different direction so they have a different viewing angle with respect to the subjects 115, 117 and 119 to be displayed.

FIG. 7(d) is a diagram of an exemplary linear camera arrangement for producing a pseudo holographic display from images in accordance with an embodiment of the present invention. The five cameras 105, 107, 109, 111 and 113 are positioned so that each camera is pointed in the same different but in a different position so they have a different viewing angle with respect to the subjects 115, 117 and 119 to be displayed.

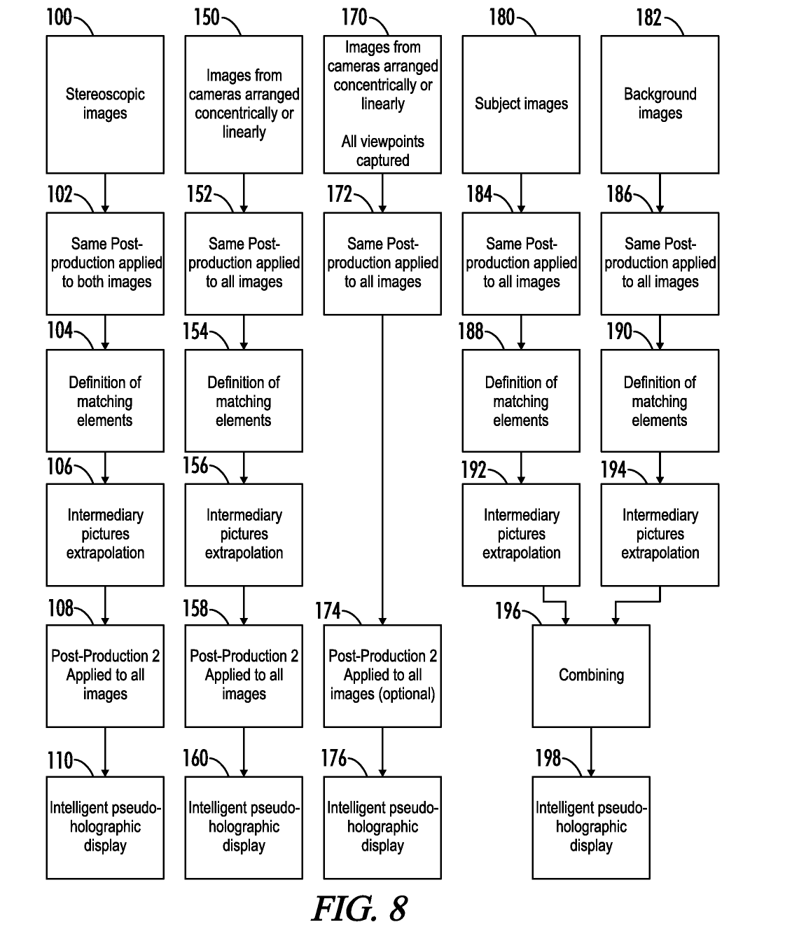

FIG. 8 is a series of flowcharts of various alternative methods of producing a pseudo holographic display from the stereoscopic camera images created by different camera arrangements in accordance with the present invention. A method of creating a pseudo holographic display with a pair of stereoscopic images begins with acquiring of the stereoscopic images in step 100. Similar post production processing is then applied to the images in step 102. Matching elements in the processed images are defined in step 104. Intermediary images are then extrapolated from the stereoscopic images in step 106 and post production processing applied to all of the images in step 108. Finally in step 110, a software algorithm in the device determines the orientation of the device and selects an image for display such that an intelligent pseudo holographic display is created.

A method of creating a pseudo holographic display with a series of cameras arranged concentrically or linearly begins with acquiring of the images in step 150. Similar post production processing is then applied to the images in step 152. Matching elements in the processed images are defined in step 154. Intermediary images are then extrapolated from the images in step 156 and post production processing applied to all of the images in step 158. In step 160, a software algorithm in the device determines the orientation of the device and selects an image for display such that an intelligent pseudo holographic display is created.

A method of creating a pseudo holographic display with a series of cameras arranged concentrically or linearly from only actual camera images begins with acquiring of the images in step 170. Similar post production processing is then applied to the images in steps 172 and 174. In step 176, a software algorithm in the device determines the orientation of the device and selects an image for display such that an intelligent pseudo holographic display is created.

A method of creating a pseudo holographic display with both a subject layer and a background layer begins with acquiring of the subject images in step 180 and background images in step 182. Similar post production processing is then applied to the images of the subject in step 184 and similar post production processing is then applied to the images of the background in step 186. Matching elements in the processed subject and background images are defined in steps 188 and 190. Intermediary images are then extrapolated from the images in steps 192 and 194. The subject and background images are then combined in step 196. In step 198, a software algorithm in the device determines the orientation of the device and selects the appropriate subject and background image for display such that an intelligent pseudo holographic display is created.

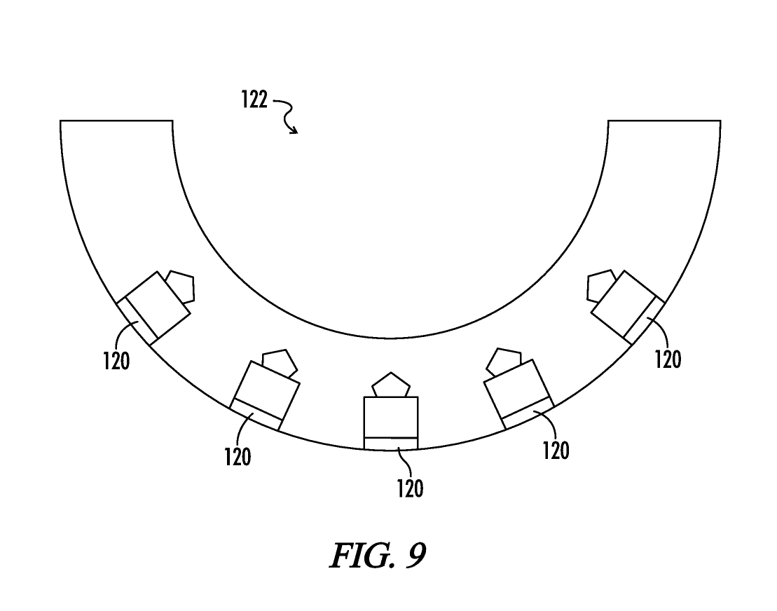

Additional cameras can be used to further refine the pseudo holographic effect. FIG. 9 is a diagram of an exemplary concentric camera arrangement for producing a pseudo holographic display from images in accordance with an embodiment of the present invention. The camera arrangement consists of a series of cameras 120 placed concentrically around a subject 122. The pseudo holographic effect is created by acquiring images from each of the concentric cameras. If a large number of cameras are used, it may not be necessary to produce any intermediary images. The actual images can be captured each by an individual camera or a camera can be used to capture each viewpoint by moving to each desired position.

The foregoing description and summary of the invention with the preferred embodiments accompanied by the drawings should not be construed to limit the scope of the invention. It should be understood and obvious to one skilled in the art that the embodiments of the invention thus described may be further modified without departing from the spirit and scope of the invention.

What is claimed is:

1. A method of producing a pseudo holographic visual effect, said method comprising the steps of:
acquiring at least two actual images of a single subject for use in producing the visual effect wherein each image represents a different viewing angle of the single subject;
determining a viewing angle of a display device; and
selecting one of said at least two actual images to display based upon said viewing angle of said display device.

2. The method of claim 1 further comprising the step of calculating at least one intermediary virtual image wherein said intermediary virtual image is extrapolated from said at least two actual images and wherein said step of selecting one of said at least two actual images further comprises selecting one of said at least two actual images and said at least one intermediary image to display based upon said viewing angle of said display device.

3. The method of claim 1 wherein said at least two actual images further comprise a pair of parallel stereoscopic images.

4. The method of claim 1 further comprising the step of extrapolating secondary intermediate images based on upon said at least one intermediary virtual image and said at least two actual images.

5. The method of claim 1 wherein the step of acquiring at least two actual images of a single subject further comprises acquiring a series of concentric images of said single subject.

6. The method of claim 1 further comprising the step acquiring at least two actual images of a background and displaying said images of said background behind said behind said images of said single subject based upon said detected viewing angle.

7. A system for producing a pseudo holographic visual effect on a display screen of an electronic device, said system comprising:
a camera for producing a first subject image of a subject from a first viewing angle and a second subject image of a subject from a second viewing angle;
software residing in said electronic device that extrapolates at least one intermediary subject image from said first and second subject images;
software residing in said electronic device that determines an orientation of said electronic device; and
software residing in said electronic device that selects one of said first subject image, said second subject image or said intermediary subject image based upon said determined orientation of said electronic device.

8. The system of claim 7 wherein said orientation of said electronic device is determined based upon an output of an accelerometer.

9. The system of claim 7 wherein said subject images are selected for display such that said subject appears to face in one direction when an orientation of said electronic device is altered.

10. The system of claim 7 wherein said camera further produces a first background image and second background image and said background images are displayed behind said images of said subject based upon an orientation of said electronic device such that said subject appears to be in front of said background.

11. The system of claim 7 further comprising a camera positioned to create a user image of a user of said electronic device and software that determines when said user moves based upon said user image.

12. The system of claim 7 further comprising a camera for producing a first background image of a background from a first viewing angle and a second background image of said background from a second viewing angle; software residing in said electronic device that extrapolates at least one intermediary background image from said first and second background images; and software residing in said electronic device that selects one of said first background image, said second background image or said intermediary background image to display based upon said determined orientation of said electronic device.

13. The system of claim 7 wherein said orientation of said electronic device is based upon a detected position of a user's finger on a touch sensitive display of said electronic device or mouse of said electronic device.

14. The system of claim 7 wherein said camera further comprises a series of cameras positioned concentrically around said subject.

15. The system of claim 7 wherein said electronic device comprises a mobile phone.

16. The system of claim 7 wherein said electronic device further comprises a desk top computer.

17. A method of producing a pseudo holographic display, said method comprising the steps of:
acquiring at least two subject images of a subject for use in producing the pseudo holographic display wherein each subject image represents a different viewing angle of the subject;
calculating at least one intermediary subject image of said subject wherein said intermediary subject image is a composite of said at least two actual images of said subject;
acquiring at least two background images of a background for use in producing the pseudo holographic display wherein each background image represents a different viewing angle of the background;
calculating at least one intermediary background image of said background wherein said intermediary background image is a composite of said at least two actual images of said background;
determining a viewing angle of a display device; and
selecting one of said at least two subject images and said at least one intermediary subject images to display based upon said determined viewing angle of said display device; and
selecting one of said at least two background images and said at least one intermediary virtual background images to display contemporaneously with said selected subject image based upon said determined viewing angle of said display device such that said selected subject image appears to be in front of said selected background image.

18. The method of claim 17 wherein said step of determining a viewing angle of said device is repeatedly performed according to a set time schedule or by an interrupt signal generated by a sensor

19. The method of claim 17 wherein said step of determining a viewing angle of said device further comprises processing a camera image of a viewer to determine said viewing angle of said device.

20. The method of claim 17 further comprising the step of processing said subject images and said background images to improve an appearance of said subject images and said background images.
